(19) United States
(12) Patent Application Publication
(10) Pub. No.: US 2004/0088148 A1
(43) Pub. Date: May 6, 2004

(54) Fast network simulation using network decomposition

(76) Inventors: Boleslaw K. Szymanski, Newtonville, NY (US); Bin Mo, Ayer, MA (US)

Correspondence Address: Dickstein Shapiro Morin & Oshinsky, 2101 L Street NW, Washington, DC, 20037-1526, US

(21) Appl. No.: 10/433,323

(22) PCT Filed: Dec. 3, 2001
(86) PCT No.: PCT/US01/45109

(51) Int. Cl. G06F 17/50

(52) U.S. Cl. 703/13

(57) ABSTRACT

The invention provides a system for network simulation utilizing network decomposition. The network is decomposed into parts and is simulated independently and concurrently with the others. The simulation is suspended or frozen and these parts exchange information periodically about the packet delays and drop rates along the paths within each part. Each part iterates over the selected simulated time interval until the exchanged information changes less than the prescribed tolerance. Each decomposed part may represent a subnet or a sub-domain of the entire network, thereby mirroring the network structure in the simulation design. The system is independent of the simulator technique employed to run simulators of the parts of the decomposed network. In other words, the present system provides for an efficient parallelization of network simulation based on convergence to the fixed-point solution of inter-part traffic. The system can be used in all applications in which the speed of the simulation is crucial.

The United States Government has certain rights in this invention pursuant to the Defense Advanced Research Projects Agency (DARPA) Contract Number F30602-00-2-0537 between the Department of Defense and Rensselaer Polytechnic Institute.

### BACKGROUND OF THE INVENTION

1. Field of the Invention

The present invention relates to a high speed transmission system in a large packet switching network and, more particularly, to a system for fast network simulation using network decomposition.

2. Description of Prior Art

Data transmission is now evolving with a specific focus on applications and by integrating a fundamental shift in the customer traffic profile. Driven by the growth of workstations, local area network (LAN) interconnections, distributed processing between workstations and super computers, as well as, new applications and the integration of various and often conflicting structures, such as, hierarchical versus peer to peer, wide (WAN) versus local area networks (LAN), voice versus data, the data profile has become higher in bandwidth, bursty, nondeterministic and requires more connectivity. It is clear that there is a strong requirement for supporting distributed computing applications across high speed networks that can carry LAN communications, voice, video, and traffic among channel attached hosts, business, engineering workstations, terminals, and small to intermediate file servers. This vision of a high speed multiprotocol network is the driver for the emergence of fast packet switching network architectures in which data, voice, and video information is digitally encoded, chopped into small packets and transmitted through a common set of nodes and links.

The major difficulty in simulating large networks at the packet level is the enormous computational power needed to execute all events that packets undergo traversing the network¹. The usual approach to providing required vast computational resources relies on parallelization of an application to take advantage of a large number of processors running concurrently. Traditional parallelization of simulation partitions network topology into Logical Processors (LPs), but the simulation is still executed as a whole. Therefore, the partitioned parts have to exchange a great amount of information to keep them synchronized with each other. In other words, such parallelization does not work efficiently for network simulations at packet level because of tight synchronization between network components². ¹L. A. Law and M. G. McComas. Simulations software for communication network: the state of the art. IEEE Communication Magazine, 32:44-50, 1994. ² R Fujimoto. Parallel discrete event simulation. Communications of the ACM, 33:31-53, October 1990.

Hence, what is needed is a scalable and efficient network simulator able to accommodate the rapidly growing complexity and dynamics of the Internet. In particular, a simulator which utilizes a collaborative on-line simulation scheme to support real-time on-line collaborative simulators.

### SUMMARY OF THE INVENTION

The present invention provides a system for fast network simulation utilizing network decomposition. The network is decomposed into parts and each part is simulated independently and simultaneously with the others. Each part represents a subnet or a subdomain of the entire network. These parts are connected to each other through paths that represent communication links existing in the simulated network. In addition, the total simulation time is partitioned into separate simulation time intervals such that the traffic characteristics change little during each time interval. The efficiency of the system is based on the fact that the simulation time of a network grows faster than size of the network.

For example, in the initial (zero) iteration of the simulation process, each part assumes on its external in-links either no traffic, if this is the first simulated interval (alternatively, the initial external traffic may be defined by the real-time measurements of the simulated network), or the traffic defined by the packet delays and drop rate defined in the previous simulation time interval for external domains. Then, each part simulates its internal traffic, and computes the resulting out-flow of packets through its out-links.

In the subsequent k>0 iteration, the inflow into each part from the other parts will be generated based on the out-flows measured by each part in the iteration k−1. Once the inflows to each part in iteration k are close enough to their counterparts in the iteration k−1, the iteration stops and the simulation either progresses to the next simulation time interval or completes execution and produces the final results.

In other words, in a network T=(N,L), where N is a set of nodes and L (a subset of Cartesian product N×N), is a set of unidirectional links connecting them (bi-directional links are simply represented as a pair of unidirectional links). Let (N₁, . . . , N_{q}) be a disjoint partitioning of the nodes, each partition modeled by a simulator. For each subnet Ni, a set of external out links is defined as Oᵢ=L & Nᵢ×(N−Nᵢ), in-links as 1ᵢ=L & (N−Nᵢ)×Nᵢ and local links 21 as Lᵢ=L & Nᵢ×Nᵢ.

The purpose of a simulator Sᵢ that model partition Nᵢ of the network, is to characterize traffic on the links in its partition in terms of a few parameters changing slowly compared to the simulation time interval. In the implementation presented in this application, each traffic is characterized as an aggregation of the flows, and each flow is represented by the activity of its source to the boundary of that part. Since the dynamics of the source can be represented by the copy of the source replicated to the boundary, the traffic is characterized by the packet delays and drop rates on the relevant paths.

The method can be applied in, for example, all applications in which the speed of the simulation is of essence such as on-line network simulation, ad-hoc network design, emergency network planning, large network simulation, and network protocol verification under extreme conditions (large flows) as well as transportation networks, etc.

### BRIEF DESCRIPTION OF THE DRAWINGS

The foregoing and other advantages and features of the invention will become more apparent from the detailed description of preferred embodiments of the invention given below with reference to the accompanying drawings in which:

FIG. 1 depicts a progress of the simulation execution according to an exemplary embodiment of the present invention;

FIG. 2 depicts an active domain with connections to other domains;

FIG. 3 depicts a 64-node network showing flows from a sample node;

FIG. 4 depicts a 27-node network showing flows from a sample node;

FIG. 5 depicts a simulation vs. execution time on Sun Solaris for the 64-node network with different decompositions; and

FIG. 6 depicts a simulation vs. execution time on Sun Solaris for 27-node network with different decompositions.

### DETAILED DESCRIPTION OF PREFERRED EMBODIMENTS

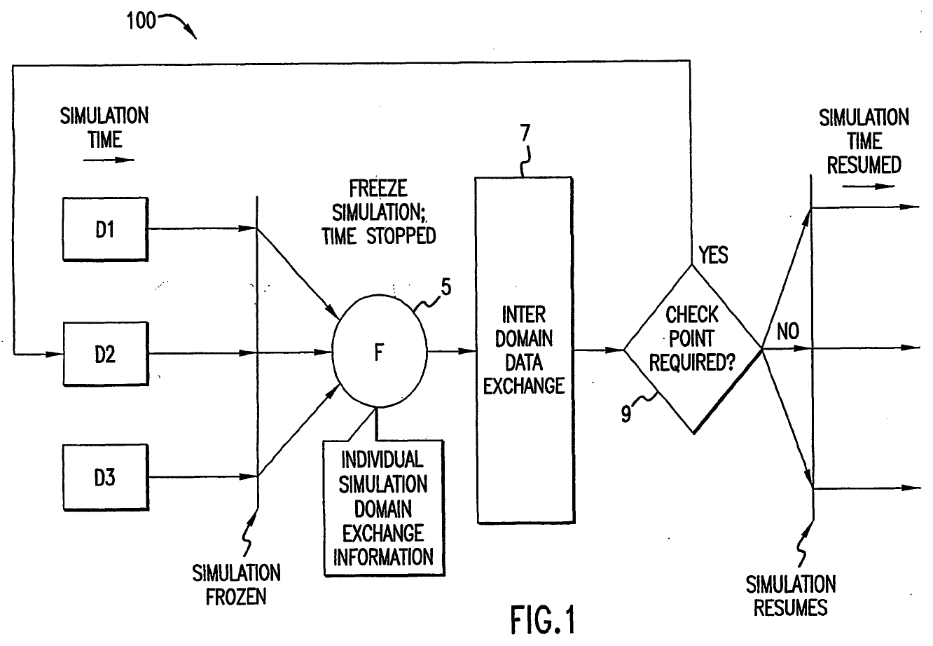

The present invention will be described in connection with exemplary embodiments illustrated in FIGS. 1-6. Other embodiments may be realized and other changes may be made to the disclosed embodiments without departing from the spirit or scope of the present invention.

### Implementation

Referring now to FIGS. 1, 2 and 3, there is shown a system for network simulation 100 of the present invention. The design of system 100 is based on a ns network simulator³. In ns, a simulation is defined by Tcl scripts which can also be used to interface the core of the simulator. The kernel of the simulations system is written in C++. The ease of adding extensions and rich suite of the network protocols makes ns a good platform for network research in networking. The extension to ns enable collaboration among individual parts into which the simulated network is divided. Since network domains are convenient granules for such partitioning, these parts can be referred to as simulation domains or domains 1, 2, 3, in short. Each domain is simulated by a separate copy of ns running on a unique processor. ³NS network simulator. http://www-mash.cs.berkeky.edu/ns.

As depicted in FIG. 1, a new genetic event called Freeze has been added to ns. It pauses the simulation at intervals defined by the user. During the event execution, it executes functions provided by the user in Freeze definition. On return, Freeze reactivates the simulation. This ability to suspend the simulation to enable exchange of data on path delays using message passing between processors simulating individual domains is important. During the freeze simulation at segment 5, each individual simulation domain exchanges information at segment 7 on packets 15 generated and dropped along links 17, 19 leaving the domain 1. Each of the domain simulations 01, 02, 03 run concurrently with the others and they exchange information about the path delays incurred by packets 15 leaving the domain 1, 2, 3. The interval for exchange of this information is user configurable (in the Tcl script). For example, each domain may run its individual simulations for one second from nth to n+1-st second of the simulation time, and pause thereafter. Then, information about delays of packets 15 leaving the domain 1 during this time interval is passed onto the target domain 2, 3 to which these packets 15 are directed.

If these delays differ significantly from what was assumed in the target domain, the simulation of the time interval (n, n+1) is repeated at segment 9. In other words, a check point is required. Otherwise, if a check point is not required at segment 9, the simulations 01, 02, 03 (relating to domain 1,2, 3, respectively) progress to the time interval (n=1, n=2). The threshold value of the difference between the current delays and the pervious ones under which the simulation is allowed to progress in time is set by the user. This threshold impacts the speed of the simulation progress and defines the precision of the simulation results.

Note, the system 100 has the ability to record information about the delays and drop rates experienced by the packets 15 leaving the domain 1. Each delay measures the time expired from the instance a packet 15 leaves its source 23 by flow 25 to the time it reached the domain boundary. Packet 15 drop rates are computed for each flow 25 separately. Also recorded is information about each packet source 23 and its intended destination. Having this information enables the system 100 to replicate the source 23 from the original domain 1 to the boundary of the target domain 2, 3 and postpone an arrival of each packet 15 produced by the replicated sources 23 at the domain boundary by the delay measured in the source (and transient, if necessary) domains. Also, with probability defined by packet 15 drop rates, packets 15 are randomly dropped during the passage to the boundary of the destination domain 24.

Also, the present system 100 has the ability to define domain members and identify individual sources 23 within the domain that generate packets 15 intended for nodes external to the domain. This feature enables direct connection to a source 23 to the destination domain 24 to which it sends packets 15 (such replicated sources are referred to as a fake source and to the link that connects it to the domain internal nodes 13 as a fake link, as further explained below). The domain is defined by the user using a Tcl level command which takes as its parameters the nodes that the user marks as belonging to the domain. Then, the simulation of this domain is created by deactivating all domains external to the selected domain.

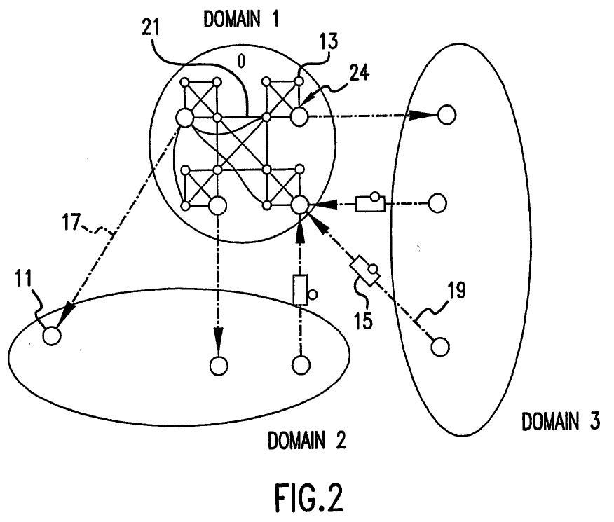

For example, the network in FIG. 2 is split into three individual domains 1, 2, 3. In the initial (zero) iteration of the simulation process, each domain 1, 2, 3 assumes on its external in-links 19 either no traffic, if this is the first simulated interval (alternatively, the initial external traffic may be defined by the real-time measurements of the simulated network), or the traffic defined by the packet delays and drop rate defined in the simulation time interval for external domains. Then, each domain simulates its internal traffic, and computes the resulting out-flow of packets 15 through its out-links 17, 19.

In the subsequent k>0 iteration, the inflow into each part from the other parts will be generated based on the out-flows measured by each part in the iteration k−1. Once the inflows to each part in iteration k are dose enough to their counterparts in the iteration k−1, the iteration stops and the simulation either progresses to the next simulation time interval or completes execution and produces the final results.

In other words, in a network T=(N,L), where N is a set of nodes and L (a subset of Cartesian product N×N), is a set of unidirectional links connecting them (bidirectional links are simply represented as a pair of unidirectional links). Let (N₁, . . . , N_{q}) be a disjoint partitioning of the nodes, each partition modeled by a simulator. For each subnet N₂, a set of external out links is defined as Oᵢ=L & Nᵢ×(N−Nᵢ), in-links as lᵢ=L & (N−Nᵢ)×Nᵢ and local links 21 as Lᵢ=L & N×Nᵢ.

The purpose of a simulator Sᵢ that model partition Nᵢ of the network, is to characterize traffic on the links in its partition in terms of a few parameters changing slowly compared to the simulation time interval. In the implementation presented in this paper, we characterize each traffic as an aggregation of the flows, and each flow is represented by the activity of its source to the boundary of that part. Since the dynamics of the source can be represented by the copy of the source replicated to the boundary, the traffic is characterized by the packet delays and drop rates on the relevant paths.

Theoretical analysis indicated that for the network size of order O(n), the simulation time contains terms which are of order O(n*log(n)), that correspond to sorting event queue of order O(n²), that result from packet routing and even order O(n³), that are incurred while building routing tables. Some of the simulation performance measurements indicate that the dominant term is of order O(n²) even for small networks⁴. Using the least squared method to fit the measured execution time for the different network sizes, we got the following approximate formula for star-interconnected networks: ⁴ T. Ye, D. Harrison, B. Mo, S. Kalyanaraman, B. Szymanski, K. Vastola, B. Sikdar, and H. Kaur. Traffic management and network control using collaborative on-line simulation. In Proc. International Conference on Communication, ICC2001, 2001.

T(n)=3.49+0.8174×n+0.0046×n²

where T is the execution time of the simulation, and n is the number of nodes in the simulation. From the above, the execution time of a network simulation may hold a quadratic relationship with the network size. Therefore, it is possible to speed up the network simulation by splitting the network into smaller pieces and parallelizing the execution of these pieces.

For example, as demonstrated below, a network decomposed into 16 parts will require less than 1/16 of the time of the entire sequential network simulation (so also less computational power, because there are 16 parts each needing less than 1/16 of the computational power of the sequential simulator), despite the overhead introduced by external network traffic sources added to each part (as explained below) and synchronization and exchange of data between parts. Hence, with modest number of iterations, the total execution time can be cut an order or magnitude or more.

Note, the direct method of representing the traffic on the external links as a self-similar traffic defined by a few parameters may also be utilized. These parameters can be used to generate the equivalent traffic using on-line traffic generator described in⁵. No matter which characterization is chosen, based on such characterization, the simulator can define the overall characterization of the traffic through the nodes of its subnet. For instance, let ξk (M) be a vector of traffic characterization of the links in set M in k-th iteration. Then, each simulator can be thought of as defining a pair of functions: ⁵M. Yuksel, B. Sikdar, K. S. Vastola, and B. Szymanski, Workload generation for ns simulation of wide area networks and the internet, In Proc, Communication Networks and Distributed Systems Modeling and Simulation Conference, pages 93-98. SCS Press.

$$\begin{matrix}{ξ}_{k} ( {O}_{i} ) = {f}_{i} ( {ξ}_{k - 1} ( {I}_{i} ) ) , {ξ}_{k} ( {L}_{i} ) = {g}_{i} ( {ξ}_{k - 1} ( {I}_{i} ) ) \\ ( or , symmetrically , {ξ}_{k} ( {I}_{i} ) , {ξ}_{k} ( {L}_{i} ) can be defined in terms of {ξ}_{k - 1} ( {O}_{i} ) ) ,\end{matrix}$$

Each simulator can then be run independently of others using the measured or predicted values of ξₖ(Iᵢ) to compute its traffic. However, when the simulators are linked together, then

$${⋃}_{i = 1}^{q} {ξ}_{k} ( {I}_{i} ) = {⋃}_{i = 1}^{q} {ξ}_{k} ( {O}_{i} ) = {⋃}_{i = 1}^{\overline{q}} {f}_{i} ( {ξ}_{k - 1} ( {I}_{i} ) ) ,$$

so the global traffic characterization and its flow is defined by the fixed-point solution of the equation.

$${⋃}_{i = 1}^{q} {ξ}_{k} ( {I}_{i} ) = F ( {⋃}_{i = 1}^{q} ( {ξ}_{k - 1} ( {I}_{i} ) ) ,$$

where F(∪ᵢ₌₁^{q}(ξₖ₋₁(Iᵢ)) is defined as ∪ᵢ₌₁¹fᵢ(ξₖ₋₁(Iᵢ)). The solution can be found iteratively starting with some initial vector ξ₀(Iᵢ), which can be found by measuring the current traffic in the network.

The communication networks simulated this way should converge due to the monotonical nature of the path delay and packet drop probabilities as the function of the traffic intensity (congestion). For example, if in an iteration k a part Ni of the network received more packets than the fixed-point solution would deliver, then this part will produce fewer packets than the fixed-point solution would. These packets will create inflows in the iteration k+1. Clearly then, the fixed point solution will deliver the number of packets that is bounded from above and below by the numbers of packets generated in two subsequent iterations Iₖ and Iₖ₊₁ Hence, in general, iterations will produce alternatively too few and too many packets in the inflows providing the bounds for the number of packets in the fixed point solution. By selecting the middle of each bound, the number of steps needed to convergence can be limited to the order of logarithm of the needed accuracy, so convergence is expected to be fast. In the initial implementations of the method, the convergence for UDP traffic and small networks was achieved in 2 to 3 iterations.

### Details of Additions and Modifications to ns

### Domain Definition

Domain is a Tcl-level scripting command that is used to define the nodes, which are part of the domain for the current simulation. In the first iteration of the simulation, the traffic sources outside the domain are inactive. The traffic generated within the domain is recorded and the statistics calculated. In the following iterations, the sources active within other domains with a link to the domain in question are activated.

When a domain declaration is made in the Tcl script, the nodes defined as a parameter to this command are stored in the form of a list. Each time a new domain is defined, the new node list is added to a domain list (a list of lists). The user-selected domain is made active. Any link with one end connected to a node in another domain is defined as a cutlink. All packets sent on these links are collected for their delay and drop rate computation.

Source generators connected to sources outside the active domain are deactivated. This is done by a new Tcl script statement that attached an inactive status to nodes outside the active domain.

### Connector

The connector performs the function of receiving, processing and then delivering the packets to the neighboring node or dropping the packets. A modification has been made to this connector class which now has the added functionality of filtering out packets destined for the nodes outside the domain and storing them for statistical data calculation.

A connector object is generally associated with a link. When a link is set up, the simulator checks if this link connects node in different domains. If this is the case, this link is classified as a cross-link and the connector associated with this link is modified to record packets flowing across it. Each such packet is either forward to the neighboring node or is marked as leaving the domain based on its destination.

### Traffic Generator

Traffic Generator Class is used to generate traffic flows-according to a timer. This class is modified so that for the domain simulation, the traffic sources can be activated or deactivated. Initially, at the start of the simulation, the traffic generator suppresses nodes outside the domain from generating any traffic.

### Fake Link

Fake links are used to connect the fake sources to a particular crosslink on the border 11 of the destination domain 24. When a fake traffic source is connected to a domain by a fake link, the packets generated by this source are sent into the domain via the fake link and not the regular links which are set up by the user network configuration file. The fake link adds a delay and, with certain probability drops the packet to simulate packet's behavior during passage through the regular route. With the fake traffic sources and fake links, the statistical date from the simulation of another domain are collected, and the traffic to the destination domain is regenerated.

When a fake link is built the source connector and the destination connector must be specified. A fake link shortens the route between the two-connector objects. Each connector is identified by the nodes on both ends of it. Link connectors are managed in the border object as a link list. The flow id to build up a fake link is specified and one fake link is use for one flow.

Fake link is used to simulate a particular flow, so when the features (packets delay and drop rate) of this flow change, the fake link object needs to be updated. After updating the parameters of the fake link object, the performance for the corresponding fake link changes immediately. Fake links are managed in the border object as a link list.

### Connectors with Fake Targets

In the original version of ns, connectors are defined as a NsObject with only a single neighbor. But, the new ns simulation requires this definition to be changed to build fake links to shorten the routes for different packet flows. These fake links are set up according to the network traffic flows and each flow from the fake sources will need a separate fake link. The flows that go through on source connector may reach different cross-links, connecting this connector to some different connectors. Different flows going into one connector are sent to different fake links, which are defined as fake targets here. Thus, the connector could now be defined as a NsObject with one neighbor and a list of fake targets. When the fake connection is enabled in a connector, this connector would have a list a fake links (fake targets), and would classify the incoming packets by flow id and send them to the correct destinations.

The connector class will maintain a list of fake targets. Once a new fake link is set up from this connector, it will be added to this connector's fake target list (this is done by the shortcut method defined in the Border class).

### Border

Border is a new class added to the ns. It is the most important class in the domain simulation. A border object represents the active domain in the current simulation. The main functionality of the border class includes initializing the current domain (e.g., setting up the current domain id, assigning nodes to different domains, setting up the data exchange etc.), collecting and maintaining information about the simulation objects (e.g., list of traffic source objects, a list of the connector objects and a list of the fake link objects maintained by the border object) and implementing and controlling the fake traffic sources (e.g., setting up and updating fake links, etc.).

The border object is set up first, and its reference is made available to all objects in the simulation. A lot of other ns classes need to refer to the variables and methods in the border object. The border class has an array, which for each simulation objects stores the domain name to which this object belongs. This information is collected from domain description files that are created for the files assigned to each domain to store some persistent data needed for inter-domain data exchange and restoration of the state from the checkpoint.

All traffic source objects created in the simulation are stored. These traffic sources can be deactivated or activated using the flow id. All the connector objects created in the simulation are stored. These connectors are identified by the two nodes to which they are connected. The connector information is used to create fake links.

The traffic sources outside the current active domain are deactivated while setting up the network and domains. When a fake link is set up for a flow, the traffic source of this flow will be reactivated. The border class searches the traffic source list to find the object, and calls the reactivate method of the matching source object to reactivate this flow.

When the border receives flow information from other domains, it will set up a fake link for this flow, and initialize the parameter of the fake link using the received statistical data. When setting up a fake link, it goes through the connector list to find the source and the destination of the connector objects, and then shortcuts the route between them by adding a fake target into the source connector. All the created fake link objects are stored in the border as a linked list ready for further update.

### Checkpointing

This feature has been included in ns to enable to simulation to easily rerun over the same simulation time interval. Diskless checkpointing is used in which each client process creates a child when it leaves a freeze point. The child is suspended, but preserves a static of the parent at the freeze time. The parent proceeds to the next freeze point. Once there, the parent decides whether to return to the previous state, in which case it unfreezes the child and then destroy itself, or to continue the simulation to the next time interval, in which case the suspended child is destroyed. This method is efficient because the process memory is not duplicated initially; later only pages that become different for the parent and child are duplicated during execution of the parent. The only significant cost is the execution of a fork statement creating a child, which is several orders of magnitude smaller than saving the state to disk.

### Synchronizing Individual Domain Simulations

Individual domain simulations are distributed across multiple processors using a client-server architecture. Multiple clients connect to a single server that handles the message passing between them. The server is defined as a single process to avoid the overhead of dealing with multiple threads and/or processes. The server uses two maps (data structures). One map keeps track of the number of clients that have already supplied the delay data for the destination domain. The other map is toggled by clients that need to perform checkpointing. All messages to the server are preceded by Message Identification Parameters which identify the state of the client. A decision whether to checkpoint the current state or to restore the saved state is made by the client based on the comparison of packet delays and drop rates in two subsequent iterations.

A client indicates to the server whether it requires checkpointing in the contents of the message itself. A client which has to checkpoint causes all other client to block until it has resent the data to the server and the server has delivered it to the destination domain (in other words a domain on another machine). This is achieved by exchanging the maps at the end of each iteration during the simulation freeze.

### Performance

Two sample network configurations are utilized, one with 64 and the other with 27 nodes to measure the performance of the simulation method on two platforms: Sun Solaris and IBM Netfinity FreeBSD workstations. Both networks are divided into a hierarchy of domains. The rate at which sources generate traffic are varied to generate temporal congestion in the network, especially at the nodes at the borders of the domains. All sources produce Constant Bit Rate (CBR) traffic with constant packet size of 64 bytes.

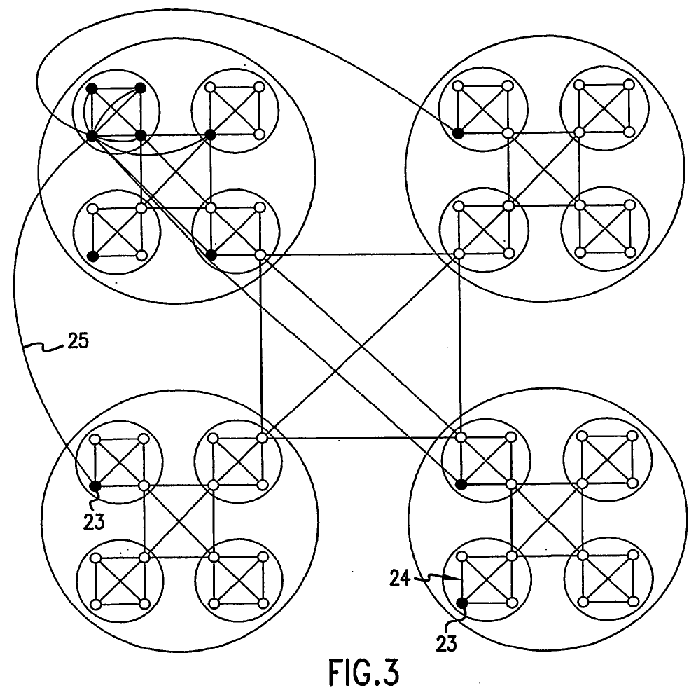

The 64-node network is designed with a great deal of symmetry. The smallest domain size is four nodes and there is full connectivity between these nodes. Such domains together are considered as a larger domain in which there is full connectivity between the four sub-domains. Finally, four large domains are fully connected and form the entire network configuration (see FIG. 3).

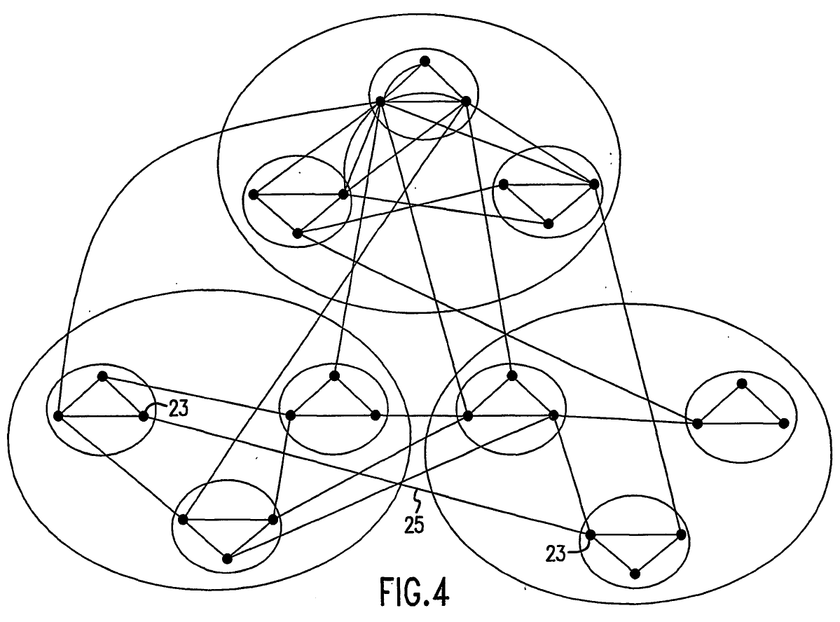

The 27-node network is a PINNI network with a hierarchical structure⁶. Its smallest domain is composed of three nodes. Three such domains form a larger domain and three large domains form the entire network (see FIG. 4). ⁶S. Bhatt, R Fujimoto, A. Ogielski, and K. Perumalla. Parallel simulation techniques for large-scale networks. IEEE Communications Magazine, 36, 1998.

### 64-Node Network

Each node in the network is identified by three digits x, y, z where 0≦x y, z≦3, that identify domain, subdomain to which the node belongs.

Each node has nine flows originating from it. In addition, each node also acts as a sink to nine flows. The flows from a node x, y, z go to nodes:

| | | |
|---|---|---|
| x.y.(z + 1)% 4 | x.y.(z + 2)% 4 | x.y. (z + 3)% 4 |
| x.(y + 1)% 4z | x.(y + 2)% 4.z | x.(y + 3)% 4.z |
| (x + 1)% 4.y.z | (x + 2)% 4y.z | (x + 3)% 4.y.z |

Thus, this configuration forms a hierarchical and symmetrical structure on which the simulation is tested for scalability and speedup.

In set of performance measurements, the sources at the borders of domains produce packets at the rate of 2000 packets/sec for half of the simulation time. The bandwidth of the link is 1.5 Mbps. Thus, certain links are definitely congested and congestion may spread to some other links as well. For the other half of the simulation time, these source produce 1000 packets per second. Since such flows require less bandwidth than provided by the links connected to each source, congestion is not an issue. All other sources produce packets at the rate of 100 packets/sec for the entire simulation. For the performance measurements, only sources that produced CBR traffic were defined and the speedup was measured by comparing simulation times of domains to the simulation time of the entire network (excluding synchronization time).

Speed up was measured for this configuration over simulation of 60 seconds of traffic. The simulation interval was set at 14.9999 seconds, resulting in five freezes. The simulation speedup with 16 processors (domains with four nodes each) was superlinear on both Sun Solaris (see FIG. 5) and IBM Netfinity FreeBSD platforms (see Table 1), despite repetitive simulations over some of the intervals. The decomposed simulation required at most two iterations to converge to the solution in each simulation time interval. The differences in the total number of packets in each flow, the number of dropped packets and the sizes of the queues at the routers were well below 1% for all three domain sizes.

### 27-Node Configuration

The network configuration shown in FIG. 4, the PINNI network adopted from [6], consists of 27 nodes arranged into 3 different levels of domains containing three, nine and 27 nodes, respectively. Each node has six flows to other nodes in the configuration and is receiving six flows from other nodes. The flows from a node x, y, z can be expressed as:

| | |
|---|---|
| x,y,(z + 1)% 3 | x,y,(z + 2)% 3 |
| x,(y + 1)% 3.z | x,(y + 2)% 3.z |
| (x + 1)% 3.y.z | (x + 2)% 3.y.z |

In these, as in the previous performance measurements, the sources at the borders of domains produce packets at the rate of 2000 packets/sec for half of the simulation time. The bandwidth of the link is 1.5 Mbps. Thus, congestion is definitely produced on certain links shown above and congestion may be produced on certain other links. For the other half of the simulation, these sources produce 1000 packets which is less than total bandwidth of the links connected to each of them. All other sources produce packets at the rate of 100 packets/sec for the entire simulation. We measured the speed up for this configuration over 60 seconds of simulated traffic. The simulation interval was set at 14.9999 seconds, resulting in five freezes.

| size of domain | 27 nodes | 64-nodes |
|---|---|---|
| large = 1 proc/domain | 3946.8 | 1714.5 |
| medium = 3/(4) procs/domains | 776.0 | 414.7 |
| small = 9(16) procs/domains | 237.3 | 95.1 |
| speed up for small domain | 12.4 | 18.0 |

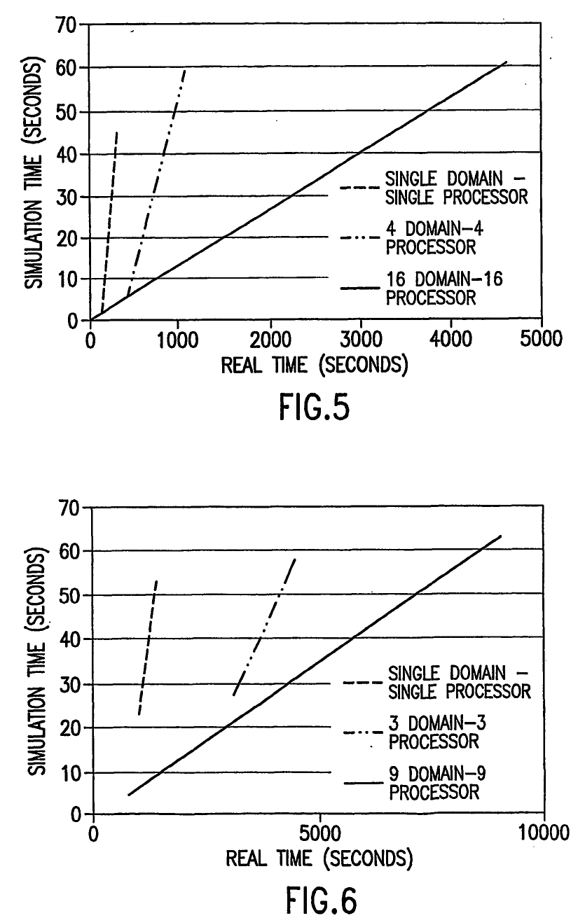

The simulation with 9 processors achieved superlinear speedup both on Sun Solaris (see FIG. 6) and for IBM Netfinity FreeBSD platform (see Table 1 above).

This configuration is less regular then the 64-node configuration and as result, the number of iterations needed for convergences varied from two to four. The differences in the total number of packets in each flow, the number of dropped packets and the sizes of the queues at the routers were well below 1% for all three different domain sizes.

### Conclusions

Hence, the invention provides a system for network simulation utilizing network decomposition. The system decomposes the network into separate domains or parts. Each part of this decomposition is simulated separately from and concurrently with the other over the simulation interval. Then, the simulations are repeated using the output of the other parts as their input until there is no significant difference between the results of two consecutive iterations. This approach greatly simplifies the synchronization between parallel parts and it decreases its frequency. Thus, the system can significantly speed up the simulation of large networks. Superlinear speedup for the single iteration step is possible due to the non-linear complexity of the network simulation.

In addition to the speedup, the advantages of the present system include fault tolerance, ability to integrate simulations and models in one run and support for truly distributed execution. When one of the participating processes falls, the rest can use the old packet delay and drop rate data to continue a simulation. When the only information available about a domain are delays across the domain and its outflows, the simulation of the other parts of the networks can directly use these data to perform the simulation. Finally, the scheme can be implemented in the fully distributed fashion, in which a domain is simulated using computational resource within itself.

While the invention has been described in detail in connection with preferred embodiments known at the time, it should be readily understood that the invention is not limited to the disclosed embodiments. Rather, the invention can be modified to incorporate any number of variations, alterations, substitutions or equivalent arrangements not heretofore described, but which are commensurate with the spirit and scope of the invention. For example, although the invention has been described with reference to a ns network simulator, other simulators can also be utilized, with similar performance benefits, such as a ssfnet simulator⁷. Also, although the invention is described with reference to the simulation of non-feedback based traffic (such as UDP-based traffic), the invention has been implemented on TCP-based traffic as well with similar gains in performance⁸. Further, the system can be applied in, for example, all applications in which the speed of the simulation is very important such as on-line network simulation, ad-hoc network design, emergency network planning, large network simulation, and network protocol verification under extreme conditions (large flows). Accordingly, the invention is not limited by the foregoing description or drawings, but is only limited by the scope of the appended claims. ⁷J. Cowie and A. Ogielski. SSFNET tutorial. http://www.ssfent.org ⁸ Genesis: A System for Large-scale Parallel Network Simulation, Boleslaw K. Szymanski, Adnan Saifee, Anand Sastry, Yu Liu and Kiran Mandani, CS Tech. Rep. 01-10, RPI, 2001, submitted to PADS2002.

What is claimed is:

1. A method for network simulation, comprising the steps of:
decomposing said network into individual parts;
simulating each said part independently and concurrently with other said parts;
freezing said simulation of said parts;
exchanging and comparing information between said parts at a predetermined interval along a path within each said part until said exchanged information changes less than a predetermined tolerance level; and
resuming said simulation.

2. The method of claim 1 further comprising the step of recording said information by said part prior to said exchange.

3. The method of claim 1 wherein said information comprises packet delays and drop rates.

4. The method of claim 1 wherein said part represents a subnet/subdomain of said network.

5. The method of claim 1 wherein said method is utilized in applications consisting of on-line network simulation, network management, ad-hoc network design, emergency network planning, large network simulation and network protocol verification.

6. The method of claim 1 wherein said path is a communication link between said parts.

7. The method of claim 1 wherein said method is based on an ns network simulator.

8. The method of claim 1 wherein said predetermined interval is user defined based upon speed and precision of said simulation.

9. The method of claim 1 further comprising the step of identifying individual sources within said part that generates said information to be exchanged with said other parts.

10. The method of claim 9 wherein said source is a fake source.

11. The method of claim 9 wherein said source is connected to said parts by a fake link.

12. A method for network simulation comprising the steps of:
freezing said simulation of a decomposed network and exchanging and comparing information between said decomposed network at a predetermined interval along a path within each said decomposed network until said exchanged information changes less than a predetermined tolerance level and resuming simulation.

13. The method of claim 12 wherein said simulation of said decomposed network is performed independently and concurrently with each other.

14. The method of claim 12 further comprising the step of recording said information by said decomposed network prior to said exchange.

15. The method of claim 12 wherein said information comprises packet delays and drop rates.

16. The method of claim 12 wherein said decomposed network represents a subnet/subdomain of said network.

17. The method of claim 12 wherein said method is utilized in applications consisting of on-line network simulation, network management, ad-hoc network design, emergency network planning, large network simulation and network protocol verification.

18. The method of claim 12 wherein said path is a communication link between said decomposed network.

19. The method of claim 12 wherein said method is based on a ns network simulator.

20. The method of claim 12 further comprising the step of identifying individual sources within said decomposed network that generates said information to be exchanged with other parts of said decomposed network.

21. The method of claim 20 wherein said source is a fake source.

22. The method of claim 20 wherein said source is connected to said parts by a fake link.

23. A method for network simulation comprising the steps of:
decomposing a network into a first domain and a second domain;
simulating each said domain independently and concurrently;
pausing said simulation of said domain;
passing information from said first domain to said second domain at a predetermined interval along a path;
comparing said passed information with information in said second domain; and
resuming said simulation if said compared information changes less than a predetermined tolerance level.

24. The method of claim 23 further comprising the step of repeating said simulation if said compared information changes more than a predetermined tolerance level.

25. The method of claim 23 further comprising the step of recording said information by said first domain prior to said passing step.

26. The method of claim 23 wherein said information comprises packet delays and drop rates.

27. The method of claim 23 wherein said domain represents a subnet/subdomain of said network.

28. The method of claim 23 wherein said method is utilized in applications consisting of on-line network simulation, network management, ad-hoc network design, emergency network planning, large network simulation and network protocol verification.

29. The method of claim 23 wherein said path is a communication link between said domains.

30. The method of claim 23 wherein said method is based on a ns network simulator.

31. The method of claim 23 wherein said tolerance level is user defined based upon speed and precision of said simulation.

32. The method of claim 23 further comprising the step of identifying individual sources within said first domain that generates said information to be passed to said second domain.

33. The method of claim 32 wherein said source is a fake source.

34. The method of claim 32 wherein said source is connected to said second domain by a fake link.

35. A system for network simulation comprising a decomposed network comprising individual parts connected by a path, said system being programmed to:
independently and concurrently simulate each said part with other said parts; freeze said simulation of said parts;
exchange and compare information between said parts at a predetermined interval along a path within each said part until said exchanged information changes less than a predetermined tolerance level; and
resume said simulation.

36. The system of claim 35 further being programmed to record said information by said part prior to said exchange.

37. The system of claim 35 wherein said information comprises packet delays and drop rates.

38. The system of claim 35 wherein said part represents a subnet/subdomain of said network.

39. The system of claim 35 wherein said system is utilized in applications consisting of on-line network simulation, network management, ad-hoc network design, emergency network planning, large network simulation and network protocol verification.

40. The system of claim 35 wherein said path is a communication link between said parts.

41. The system of claim 35 wherein said system is based on a ns network simulator.

42. The system of claim 35 wherein said predetermined interval is user defined based upon speed and precision of said simulation.

43. The system of claim 35 further being programmed to identify individual sources within said part that generates said information to be exchanged with said other parts.

44. The system of claim 43 wherein said source is a fake source.

45. The system of claim 43 wherein said source is connected to said parts by a fake link.

46. A system for network simulation comprising a decomposed network comprising individual parts connected by a path, said system being programmed to:
freeze said simulation of said decomposed network and exchanged and compare information between said decomposed network at a predetermined interval along said path within each said decomposed network until said exchanged information changes less than a predetermined tolerance level and resume simulation.

47. The system of claim 46 wherein said simulation of said decomposed network is performed independently and concurrently with each other.

48. The system of claim 46 comprising being programmed to record said information by said decomposed network prior to said exchange.

49. The system of claim 46 wherein said information comprises packet delays and drop rates.

50. The system of claim 46 wherein said decomposed network represents a subnet/subdomain of said network.

51. The system of claim 46 wherein said system is utilized in applications consisting of on-line network simulation, network management, ad-hoc network design, emergency network planning, large network simulation and network protocol verification.

52. The system of claim 46 wherein said path is a communication link between said decomposed network.

53. The system of claim 46 wherein said system is based on a ns network simulator.

54. The system of claim 46 further being programmed to identify individual sources within said decomposed network that generates said information to be exchanged with other parts of said decomposed network.

55. The system of claim 54 wherein said source is a fake source.

56. The system of claim 54 wherein said source is connected to said parts by a fake link.

57. A system for network simulation comprising a decomposed network comprising at least a first domain and a second domain connected by a path, said system being programmed to:
simulate each said domain independently and concurrently;
pause said simulation of said domain;
pass information from said first domain to said second domain at a predetermined interval along said path;
compare said passed information with information in said second domain; and
resume said simulation if said compared information changes less than a predetermined tolerance level.

58. The system of claim 57 further being programmed to repeat said simulation if said compared information changes more than a predetermined tolerance level.

59. The system of claim 57 further being programmed to recording said information by said first domain prior to said passing step.

60. The system of claim 57 wherein said information comprises packet delays and drop rates.

61. The system of claim 57 wherein said domain represents a subnet/subdomain of said network.

62. The system of claim 57 wherein said system is utilized in applications consisting of on-line network simulation, network management, ad-hoc network design, emergency network planning, large network simulation and network protocol verification.

63. The system of claim 57 wherein said path is a communication link between said domains.

64. The system of claim 57 wherein said system is based on a ns network simulator.

65. The system of claim 57 wherein said tolerance level is user defined based upon speed and precision of said simulation.

66. The system of claim 57 further being programmed to identify individual sources within said first domain that generates said information to be passed to said second domain.

67. The system of claim 66 wherein said source is a fake source.

68. The system of claim 66 wherein said source is connected to said second domain by a fake link.
